(19) United States
(12) Patent Application Publication
(10) Pub. No.: US 2010/0198637 A1
(43) Pub. Date: Aug. 5, 2010

(54) Systems and Methods for Integrated Claims Processing

(76) Inventors: Jeff Jenkins, Chesterfield, MO (US); Theresa Anne Monroe, O'Fallon, MO (US); Roger Van Horn, Chesterfield, MO (US); Susan Perryman, O'Fallon, MO (US); John Ward, Wildwood, MO (US); Brian Oetjen, Fenton, MO (US); Rob Hendricks, Rogers, AR (US); Akila Ramakrishna, St. Louis, MO (US); Carmen Davis, Kirkwood, MO (US); Terry Donohue, Des Peres, MO (US); Mike Fabian, Cypress, TX (US)

Correspondence Address: LEWIS, RICE & FINGERSH, LC;ATTN: BOX IP DEPT., 600 Washington Ave., Suite 2500, ST LOUIS, MO, 63101, US

(21) Appl. No.: 12/500,999

(22) Filed: Jul. 10, 2009

Related U.S. Application Data
(63) Continuation of application No. 12/324,465, filed on Nov. 26, 2008, now abandoned.

(51) Int. Cl. G06Q 10/00

(52) U.S. Cl. 705/7

(57) ABSTRACT

Systems and methods, such as may be executed by a computer or computer network, for the management of claims related to vehicles owned by an owner of a fleet of vehicles. The systems and methods allow for a single claim record to be accessed by a vehicle repair (VR) division, which is responsible for getting the vehicle repaired and a loss control (LC) division which is responsible for allocating the costs associated with the repair. Each of the divisions works with the same record to provide for an enhanced integrative environment and improved intercommunication.

### CROSS REFERENCE TO RELATED APPLICATION(S)

This application is a Continuation of U.S. patent application Ser. No. 12/324,465, filed Nov. 26, 2008, the entire disclosure of which is herein incorporated by reference.

### BACKGROUND

1. Field of the Invention

This disclosure relates to the field of claim processing for vehicles, particularly to computer systems and methods which can be used to process accident claims for vehicles belonging to a fleet owner such as a rental vehicle agency.

2. Description of the Related Art

Nobody wants to be in a car accident. Besides the obvious concerns of injury and damage to property, less immediate concerns such as increased insurance rates, need for temporary replacement transportation, and possible civil liability can also make even the smallest fender bender a potential headache. It is well known that when accidents occur they often create a morass of paperwork, communication problems, and information quagmires.

This problem is further compounded if a vehicle involved in the accident does not belong to the party driving it. Rental vehicles, such as the cars people often use when traveling, are the most well known such situation. Recreational rentals, where people borrow a particular vehicle for a particular activity, and moving vans acquired for relocation also present unique problems in the accident situation because you have a third party necessarily involved in the resolution. The driver of the vehicle is often not directly involved in the repair or replacement of the vehicle since it isn't theirs, while the rental vehicle owner is interested in getting the vehicle back on the road as soon as is reasonably possible while also concerned with having the vehicle repaired in a safe manner.

For the operator, repair of the vehicle may not be as important once it is returned, they may likely never see or use it again and have no stake in potentially reselling it. However, the operator may have involvement in reimbursing the owner for any costs involved. For a rental/lease vehicle owner, however, the vehicle is a source of income and therefore having it damaged or destroyed creates the necessity of getting it fixed or replaced in an expeditious manner. Further, the damaged vehicle often has a permanent lost value to the owner (through no direct fault of their own) as the vehicle may be intended to be sold while it is still a relatively new model (but less desirable for renting) and once-damaged vehicles will often not sell for as much as those that have never been damaged. Therefore, where the renter is not as concerned with resale value as they may be with its ability to operate for the rest of the rental period, a rental operator may have a distinct loss of value from now having a damaged asset.

The question can be further complicated because many large rental agencies self-insure their vehicle fleet for physical damage and/or for third party liability claims. They may need to look at potential liability to themselves (either directly or indirectly) as well as repair or replacement of the vehicle. Further, for a large fleet owner or operator, simple statistics often mean that they will have a near constant stream of vehicles being damaged and repaired as well as a near constant stream of bills, and related payments, related to that damage.

Internal to the rental company there will generally be a number of divisions which will need to coordinate information in order to resolve the claim Firstly, most rental companies will need to coordinate internally with their departments which oversee vehicle repair to get the vehicle repaired, manage the fleet, and make sure that vehicles are where they need to be to meet upcoming rental demands. Those responsible for vehicle repair will need to get estimates for repair costs, coordinate repairs around the need for the vehicles, and make sure that repairs are performed cost effectively and properly. Otherwise, damaged vehicles may create problems in the operation of the rental agency's business.

The rental vehicle company must also understand what it may potentially be owed for damage to the vehicle by the renter and/or by a third party. By contract, a renter generally takes financial responsibility for any damage to or loss of the vehicle when they rent it (unless the owner contractually waives this responsibility). Therefore, the fleet owner needs to have a department tasked with orchestrating billing to those financially responsible and matching payments with the parties who should be responsible for the bills. This can present a number of additional problems as the renter may be insured through a number of different sources including their standard automobile insurance as well as certain policies (such as those through credit cards) which specifically relate to rental cars. Furthermore, a third party may also be responsible to the owner for repair or replacement of the vehicle.

Still further, the rental agency needs to be concerned about its own liability because the accident may be alleged to be at least in part the fault of the rental agency (i.e.; allegation that the vehicle had been improperly maintained). As part of potential liability, it is necessary for the rental agency to make sure that evidence, in the form of the damaged automobile, is preserved if required by law.

This complicated interaction between different divisions of the owner of the vehicle and the parties that were directly involved in the accident has resulted in an often difficult relay of information. Previously, many discussions internal to the fleet owner were performed over the phone and it was difficult to get information from one point to another as paper estimates and accounting entries may not flow between departments. For example, a damaged vehicle may be in California being repaired, while the repair is being coordinated by a regional manager in Nevada, while at the same time a loss control officer in Seattle is trying to make sure that the owner is correctly reimbursed for the costs of those repairs.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, there are described herein, among other things, systems and methods for integrated claim management for the owner of a fleet of vehicles. These systems and methods are generally computer implemented methodologies, or software for implementing such methodologies on a computer or computer network, that serve to make it easier to handle a large number of geographically and factually diverse claims that a fleet owning agency, such as, but not limited to, a rental vehicle company, receives The systems and methods can also improve flow of information on potential liability to claim adjusters of the owner, provide information on potential loss to loss control departments, and get the vehicle repaired or replaced as quickly as possible and properly.

This type of system and method, therefore, generally serves to provide both a methodology to streamline the claim process and to reduce costs imposed on a fleet owner by improving their ability to efficiently resolve claims. The system can also act as a deterrent to fraudulent claims by providing for better communication within the organization on to identify potentially fraudulent claims.

There is described herein, among other things, a method of managing claims for a fleet of vehicles, the method comprising: having a fleet owner responsible for a fleet of vehicles; providing a computer; due to damage to one of the vehicles, having a depot of the owner create a claim report in the computer; allowing a Vehicle Repair (VR) division of the owner to access the claim report and to update the claim report with repair costs and dates of expected repair completion; allowing a Loss Control (LC) division of the owner to access the claim report to indicate if the loss can be subrogated; and if the loss can be subrogated, allowing the LC to maintain an accounting as part of the claim report the accounting utilizing information entered by at least one of the VR and the depot.

In an embodiment of the method the VR can access the claim via a simplified interface which allows for updating of status of a repair without opening the claim record.

In an embodiment of the method the computer is part of a computer network.

In an embodiment of the method the computer comprises a server computer.

In an embodiment of the method the VR and the LC access the claim report on the server computer via separate client computers.

In an embodiment of the method the VR and the LC may simultaneously access the claim report.

In an embodiment of the method once the claim has been rectified, the claim report is closed.

In an embodiment of the method the claim report cannot be closed until both the LC and the VR individually close the claim report.

In an embodiment of the method the LC cannot individually close the claim report until they have indicated if there can be subrogation.

In an embodiment of the method the VR cannot individually close the claim report until they have indicated that the damaged vehicle has been repaired.

There is also described herein a computer-readable memory storing computer-executable instructions for claim management, the memory comprising: computer-executable instructions for creating a claim report in the computer; computer-executable instructions for allowing a Vehicle Repair (VR) division of an owner to access the claim report and to update the claim report with repair costs and dates of expected repair completion; computer-executable instructions for allowing a Loss Control (LC) division of the owner to access the claim report to indicate if the loss can be subrogated; and computer-executable instructions for allowing the LC to maintain an accounting as part of the claim report the accounting utilizing information entered by at least one of the VR and the depot if the loss can be subrogated.

There is also described herein a system of managing claims for a fleet of vehicles, the system comprising: a fleet owner responsible for a fleet of vehicles, the fleet owner including a plurality of depots and; a computer network to which the fleet owner and the depots have access, the computer network allowing: the depot to create a claim report in the computer network due to damage of one of the vehicles in the plurality; a Vehicle Repair (VR) division of the owner to access the claim report and to update the claim report with repair costs and dates of expected repair completion; a Loss Control (LC) division of the owner to access the claim report to indicate if the loss can be subrogated, and if the loss can be subrogated, allowing the LC to maintain an accounting as part of the claim report the accounting utilizing information entered by at least one of the VR and the depot.

### BRIEF DESCRIPTION OF THE FIGURES

FIG. 1 provides a general block diagram of the layout of an embodiment of a computer system comprising an embodiment of an integrated claim management system.

FIG. 2 provides a screenshot of general vehicle information entry.

FIG. 3 provides for an embodiment of a screenshot showing an estimate entry screen for use by a VR representative to enter estimate information.

FIG. 4 provides an embodiment of a screenshot showing a repair entry screen for use by a VR representative to enter updated repair information.

FIG. 5 provides for an embodiment of a screenshot showing a shop manager where a VR representative can quickly enter changed status information in claims.

FIG. 6 provides for an embodiment of a screenshot showing the subrogation determination by an LC representative.

FIG. 7 provides for an embodiment of a screenshot showing a subrogation cost balance sheet.

FIG. 8 provides for an embodiment of a screenshot showing assignment of repair costs to responsible parties.

FIG. 9 provides for an embodiment of a screenshot showing allocation of a payment to components of a subrogated cost total.

FIG. 10 provides an embodiment of a screenshot showing a write-off request queue.

FIG. 11 provides an embodiment of a screenshot showing a diary record, in this case for repair estimates.

FIG. 12 provides an embodiment of a screenshot showing a notes record, in this case for repair estimates.

### DESCRIPTION OF PREFERRED EMBODIMENT(S)

Generally described herein are systems and methods that relate to a computer system, such as can be implemented on an individual computing device or a computer network utilizing a memory having computer-executable instructions for providing the services and methods as discussed herein. The software and methodology generally allow the person or other entity responsible for a fleet of vehicles to manage and organize claims associated with the vehicles, particularly those claims related to accidents involving a fleet of vehicles using the computer system. The specific hardware and software layout of the system as discussed herein is intended to be purely exemplary and it would be understood to one of ordinary skill in the art how to adapt the systems and methods to use other hardware and software configurations. This system is generally referred to herein as an Integrated Claims Environment (ICE) or integrated claims management system which refers to the interactive “environment” wherein users of the system will be able to provide, exchange, and store information related to a specific claim.

For the purposes of this disclosure, the entity who is principally responsible for a fleet of vehicles will generally be referred to as the “fleet owner” or “owner.” This entity may comprise an individual, corporation, partnership or any other type of legally recognized entity who controls a fleet of vehicles. The term “owner” is not intended to require that the entity actually “own” the vehicles that are part of the fleet and they may simply manage the fleet of vehicles. Depending on embodiment, the vehicles may be owned, leased, borrowed, or be under any other type of transfer of control to the owner. However the term “owner” is used herein to distinguish the entity that is generally responsible for the fleet vehicles as opposed to the entity that is currently responsible for some subdivision of vehicles from the fleet at the time of the accident who is termed the “renter.” Further, it should be recognized that a fleet of vehicles as discussed in the embodiments herein will comprise a fleet of passenger cars and light trucks, but that is not intended to limit the types of vehicles which may be in a fleet that could utilize a system or method of the present invention. Any type of vehicle fleet, whether motorized Of not, may have claims managed using the ICE including, but not limited to, fleets including: passenger cars, light trucks, heavy trucks, vans, boats, ships, jet skis, motorcycles, bicycles, aircraft, helicopters, balloons, hovercraft, spacecraft, trailers, cargo containers, boxes, snowmobiles, ATVs, go-carts, scooters, mopeds, or any combination of these. Further, how the owner chooses to supply vehicles to the renter may be of any type including renting by the day, renting long-term, or renting on a per-hour or per-use basis.

The entity who is operating or responsible for the vehicle at the time of accident due to a contractual relationship with the owner is described herein as the “renter” of the vehicle (assuming the vehicle is rented at the time of the accident). The term “renter” can refer to an employee of the fleet owner or other temporary operator of the vehicle depending on the particular embodiment and they need not be paying “rent” to operate the vehicle. In effect, the owner controls the fleet while the renter operates at least a portion of the fleet due to their relationship with the owner. This relationship will generally be contractual and will generally require the renter to assume at least some financial responsibility for the vehicle, or have that responsibility contractually waived. The owner could have a number of renters operate a vehicle while it is under the global control of the owner but generally at most one of these would be responsible for the vehicle at the time it is damaged.

It is recognized that in some cases the renter may not be the operator of the vehicle at the time of the accident, but those are only in situations where the owner authorizes additional drivers in accordance with the vehicle rental or similar contract. In particular, a rental contract generally restricts operation of the vehicle to the renter or a secondary operator also identified when the contract is signed and for whom the renter takes responsibility. Therefore, the renter is generally contractually bound to be responsible for the operation of the vehicle and even if he or she was not actually operating it, will generally be contractually bound and responsible for whoever was.

In an extreme case, the vehicle may have been stolen or otherwise used without the owner's or renter's consent or awareness, or beyond the scope of what is permitted by the owner. In this case, the renter will generally be able to provide evidence that they were not the vehicle's operator and may not be responsible for its operation depending on the circumstances. This type of situation, however, will generally be very rare and can be handled on a case by case basis. However, even in such a situation, the renter may still be financially responsible for the vehicle. As one benefit of the ICE can be improved automation in a majority of claim situations, the general presumption of this disclosure is that the renter is the operator of the vehicle, or is otherwise responsible for the actions of the operator of the vehicle when the vehicle has been rented and this assumption is reasonable as that is the situation most of the time

The exemplary ICE described herein will also generally be discussed in conjunction with its use by a rental vehicle company (the owner) having a large fleet of vehicles distributed between various offices, branches, franchises, groups, agencies, or other depots. These “depots” may provide access to the fleet as individual entities, or may act in an agency or other relationship with the fleet owner. Because of this relationship, the term “owner” in this disclosure refers not only to the overall entity, but to each sub-entity, and any combination thereof which are responsible for at least a portion of the fleet and which provide access to at least a portion of the overall fleet to other affiliated or related entities for their use.

Generally, the depot will be initially responsible for setting up the claim and assigning a legacy claim number as a damaged vehicle will be returned to them. They may also be responsible for converting an initial claim report into an ICE claim report to provide initial information to the ICE. Further, the depot will need to determine if the vehicle needs to be repaired in the first instance. If the damage is a door ding or a scratched bumper in an area where such damage is common, it may be ignored as getting such damage repaired may, just result in a continued damage/repair cycle since such damage is commonplace in the rental area. Alternatively, if the vehicle is involved in an accident where mechanical damage is likely, it may be necessary to immediately send the vehicle for repair to avoid providing a potentially unsafe vehicle to a renter.

While the depot will generally be the initial point of contact with regards to the accident, in an alternative embodiment, the ICE may be used by a third party provider who provides access to the ICE to the fleet owner, for instance as an Application Service Provider (ASP) via the Internet. In a still further embodiment, the third party actually serves as a service company providing the ICE system for use by its own agents and providing the use of the ICE system as a service to the fleet owner, who has no direct interaction with it. In these alternatives, or other business arrangements, the depot may not serve as the first point of control.

The rental vehicle relationship is not the only type of fleet relationship that the ICE may be used to manage claims for and it is not necessary for the claim to involve a collision. The claim could relate, for example, to a criminal action (e.g. damage to the vehicle from it being broken into), may relate to damage from natural occurrences (e.g. hail damage or from the vehicle being damaged in a storm such as a hurricane or tornado), or may relate to any other action where the vehicle is damaged. Again, in such actions, the owner may or may not be liable for the cost to repair the vehicle depending on if financial responsibility had been contractually assumed at the time the damage occurred.

This disclosure will assume that the claim event is an accident in the form of a collision. That is the automobile has collided with an object resulting in damage to the automobile and also other property not under the control of the owner. Specifically, the vehicle has been damaged while it was in the possession of a renter through an occurrence which is not the malicious result of the renter. The accident may result in damage to real property (for example if the automobile had collided with a tree or building) or personal property (such as if the automobile collided with another automobile) of another, or only damage to the owner, for instance, if the vehicle collided with another vehicle of the owner.

For purposes of example, this document will presume the damage to the owner's vehicle is the principal concern and the primary component of the claim being handled. As this type of damage is present in every case, it provides for the most fundamental discussion for system operation. Damage to a third party (including the renter), whether injury or property damage, is indicated only as a potential liability for the owner. Because the system is principally focused on information flow for the purpose of integrating claims handling between different divisions or affiliated entities of the owner, the methodology for determining values for liability or repair are not particularly important in order to understand this disclosure, and therefore this disclosure will focus on what is done with the repair costs of the vehicle as opposed to how liabilities or costs may be determined.

A vehicle is considered to be rented (or the responsibility of the renter), as that term is used herein, if it is the subject of a “rental contract.” A rental contract is any agreement between the owner and the renter which allows the renter to operate the vehicle in exchange for payment, various guarantees, or other agreed terms (for instance as part of an employment relationship). The contract is transitory in that it is in effect while the vehicle is placed in the renter's possession. It may, however, provide for effects after that time period. Nonetheless, for purposes of this disclosure, the contract will be presumed to relate to the time period during which the vehicle is expected to be operated by the renter, and for which time the renter is responsible for the vehicle. The contract period thus begins when the vehicle leaves the owner's control. The contract period ends when the vehicle is officially returned and the owner releases the renter from their current obligation as the expected operator of the vehicle.

The responsibility of the renter for the vehicle is an important part of this discussion. As opposed to an insurance situation where an owner hires out a company to take financial responsibility for a vehicle in exchange for the owner paying for this insurance, a renting situation is a contractual relationship whereby the responsibility for the value of or damage to or loss of the vehicle is passed to the renter by virtue of their operating the vehicle at the time of the accident or by virtue of the contractual relationship. In these situations, the owner may be able to collect directly from the renter contractually or under standard liability claims.

The renter may be able to pass the responsibility to an insurer or other third party. However, the ability of the owner to pass on potential loss to the renter for an accident which occurred while the vehicle was under a rental contract is an important concept of this disclosure called subrogation. Subrogation refers to the ability of the owner to transfer the responsibility for the value of repair or replacement by passing that responsibility to the renter. Should the renter then provide proof of another party being responsible, that may be provided back to the owner and the owner may communicate directly with the newly responsible party. Alternatively, the owner may simply treat the renter as the direct contact, with the renter obtaining relief from the insurer, renter's employer, etc. and simply passing it on to the owner.

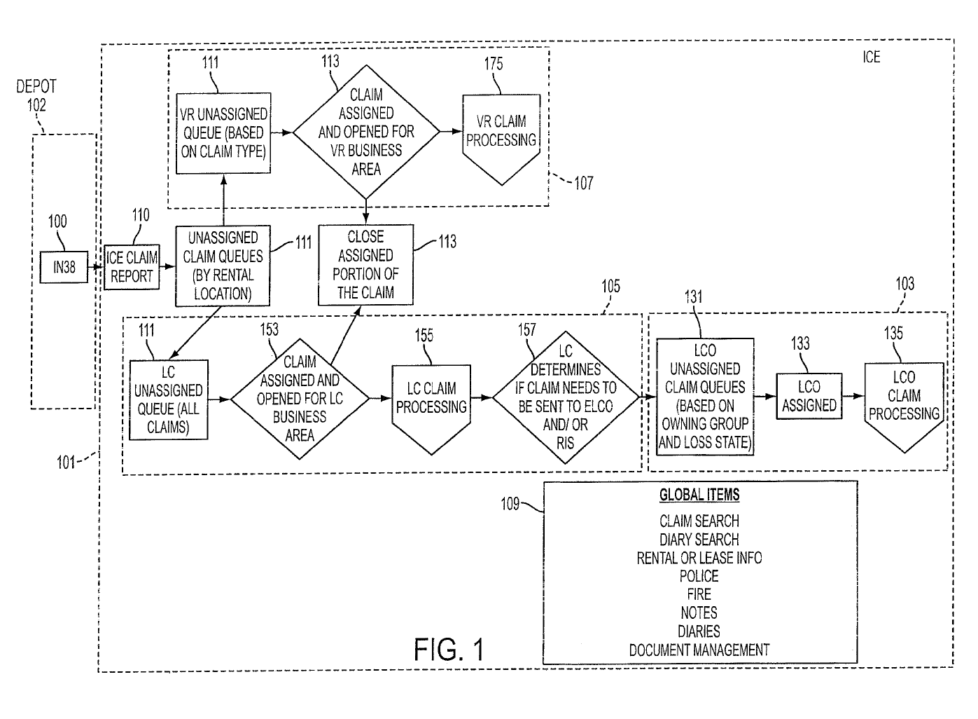

FIG. 1 provides for a general block diagram showing an embodiment of a system which can be used in an embodiment of a Integrated Claims Environment (ICE) or integrated claims management system. This diagram is a functional block diagram and shows the various functional components of an embodiment of an ICE (101). It should be recognized that as a functional diagram, there is no requirement of any particular machine to perform each block, however, in an embodiment, the functional blocks can correspond to machines, or to functional software within a machine, performing the function of the block.

Generally there are four entities involving the ICE (101), each of which will include its own internal components and activities to be performed as well as personnel trained and tasked with performing the particular operations. In order to provide for improved information flow, FIG. 1 provides for handling information amongst the various divisions of the owner. In particular, it provides for a flowchart of a generally computer implemented method for making sure that information gets to where it needs to be and is transformed and presented into a form that is useable by the entity accessing it. The system provided in the flowchart does this by creating an initial “claim report” (100) having an initial claim number which comprises a computer record of a claim related to a particular accident. This initial claim report (100) is the base line document for the ICE (101) but will generally not be a part of ICE (101). The initial claim report (100) may be stored separately and may interface with legacy computer systems to provide for additional functionality of the claim report. In an embodiment, the initial claim report (100) is uploaded, converted, or otherwise stored onto the ICE (100) and forms the initial documentation creating an ICE claim report (110). The ICE claim report (110) then is assigned an ICE claim number. This ICE claim report (110) provides for a number of features over prior claim documents as it is a singular source of information available to multiple divisions via the ICE (101) to make sure that all necessary tasks are reviewed and that necessary departments or divisions of the owner are using the same information, and are exchanging information, and that the report (110) is provided to the parties who must sign off and close the document before it can be considered complete.

The ICE (101) will generally be owned by the fleet owner who will be controlling the operation of the ICE (101) or by another entity providing the ICE (101) or results of the ICE (101) as discussed elsewhere. Generally, the ICE (101) operator will be the owner, who will have the ICE (101) running on a computer system or network and available to users who are generally employees who have been trained in its operation However, the ICE (101) may also have distributed components provided to third parties, such as repair facilities that perform work for the owner but are not directly associated with the owner.

In an alternative embodiment, any third party agents may use the ICE (101) either for their own benefit, for the benefit of the fleet owner, or as part of a fleet management or accident management service. For example, the renter, an insurance company, a vehicle repair provider, another service provider, a fleet management agency, or any combination of these or other third parties may use the ICE (101) in addition to or instead of the fleet owner. The ICE (101) will generally be provided over an internal company network in a distributed fashion so that each user will be able to use the system for vehicle damage claims generated at each individual depot under their jurisdiction. In particular, each depot will generally handle claims locally first. Additional steps may occur at local offices forming a limited number of regional jurisdictions covering a broader geographical area. In this way, they will generally only be operating on a subset of all claims of the fleet owner. Some actions may then be performed at the company wide level (or through affiliated entities) having only a single group performing these tasks for the owner. This setup, however, is by no means necessary and the ICE (101) may be set up at a central location to process all claims regardless of the corporate layout or affiliation of the owner in utilizing it.

The flowchart of FIG. 1 assumes that an accident has occurred and there is damage to a vehicle of the owner. It should be recognized that while their may be claims associated with the accident not related to a vehicle of the owner, in the vehicle rental situation it is unlikely that there would be a claim not involving damage to a vehicle of the owner which the owner would need to be concerned with. For this reason, damage to a vehicle of the owner is generally the point at which a claim is created. The initial claim document is generally created by the depot (102) which has control of the vehicle upon its return from the renter either at the end of their rental contract, or because it no longer is functional and must be replaced so the renter can continue to have a vehicle for the remainder of the rental contract period. The depot (102) is generally the renter's point of contact with the owner and the entity who has the most direct control of the vehicle when it is returned.

Generally, accident information will flow into the ICE (101) from the depot (102) by the creation of an initial claim report (100) at the depot (102). The ICE (101) will then serve as a central repository to distribute information to the remaining three entities, the Liability Control (LCO) (103) (which can be further subdivided into PIP or TORT), the Loss Control (LC) (105), and the Vehicle Repair (VR) (107) divisions of the owner. Each of these is responsible for a particular part of handling the claim report and will be discussed in brief summary here to provide an overview.

The initial claim report (100) may be entered using standard claim software or entered into specific software which is a part of ICE (101) to provide for the basics of the information related to the claim. This information may include statements by the renter made when the vehicle is returned, electronic versions of police reports or other documents, and information otherwise provided to the depot (102). Information may also be uploaded into the initial claim report (100) from other programs. Indications of payments being made directly to the depot (102) to deal with a portion of the claim (e.g. the renter providing a check for an insurance deductible at the time of the rental return) may also be indicated. Still further, the depot (102) can provide a general indication of damage and the type of repair which is necessary, as well as other costs or other details which may be associated with the repair. For example, the depot (102) may indicate that the vehicle was towed to a particular repair facility.

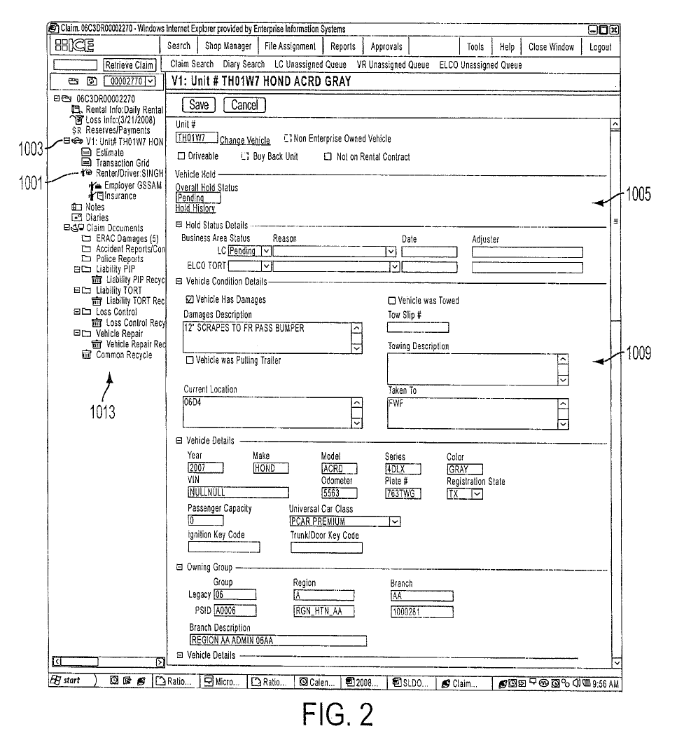

The claim report (100) will also collect information available from other computer systems which is useful in processing the claim and basic identification. For example, the depot (102) may input information related to the vehicle (1009). A screen showing the types of information which may be entered is shown in FIG. 2 as item (1005). This can include identification of the depot, identification of the vehicle (1009), and identification of damage and current situation (1011), among other things The ICE (101) may also seek out information on the owner's computer records related to the renter (1001) and/or the rental contract. For example, electronic information related to the terms of the contract as well as information provided as part of the rental such as addresses, contact information, other rentals, whether the person is part of a frequent purchaser rewards program, and rental payment details may be attached to the initial claim report (100).

It is important to recognize that the initial claim report (100) will often have a different lifetime in which it is maintained compared to records of a rental. As accidents are relatively rare compared to the total number of rental contracts made, the initial claim report (100) may be maintained for a much longer period of time. In an embodiment the initial claim report (100) will therefore not reference contract information stored elsewhere, but will actually make the contract information part of the initial claim report (100) to insure it is stored as long as the initial claim report (100) is stored.

Upon creation of the initial claim report (100), it will generally include at least the starting point of information necessary for the various divisions of the owner handling the claim to operate on. This information may be organized using a ladder or menu (1013) allowing access to specific pieces of information individually or logically grouped. Often this menu (1013), as it is depicted in various figures, will have an entry for each party involved, such as, but not limited to, the renter, third parties, insurance companies, or police or fire departments, and may have such entry for different “documents” of that entity. The claim form is then sent into the main ICE server (101) which initiates it as an ICE claim report (110) which needs to be evaluated and handled by the various divisions of the owner that now need to review and sign off or act on it. In an embodiment of the invention, the ICE (101) processor comprises a central server computer which handles ICE (101) transactions using a variety of client computer stations available to personnel in the various divisions of the owner who will work with the claim report. Specifically, the ICE claim report (110) is stored centrally (generally also with a backup) on some form of computer readable media and the various client computers which need to access, use, or alter the claim report (110), obtain the record from the server, make all required changes thereto, and allow for other client computers to access the necessary files.

Once the ICE claim report (110) has been setup on the ICE (101) server, it is placed into an unassigned claim queue (111). This is the location for all new ICE claim reports (110) which have been placed in the ICE (101) system that have not yet been taken up by any of the divisions which need to utilize them. The unassigned claims have had no action authorized on them yet or official review performed at least by the initial review divisions. Therefore, these are waiting. The queue (111) provides the source of workflow for those who work in the VR (107) and LC (105) areas who will take up new claim reports (110) from the queue (111) as those persons are in need of new work to perform. The queues will generally be arranged by location so that appropriate offices may be assigned if offices are provided in regions or locations. For example, if the rental agency has a location which handles the state of California only, it makes no sense for someone in that division to become responsible for a claim in Colorado.

Once in the ICE (101) server queue (111), the claim report (110) may be opened by any appropriate personnel in a division that needs to handle it which will assign the claim report (110) to that individual. In the depicted embodiment, the two initial offices which must handle the claim are the VR (107) and the LC (105). The LCO (103) only gets involved if there is a need for a liability determination based on original review by the LC (105). In order to obtain a new case, a user will first log into the ICE (101) system. Generally, the user's log in will be specific to them and will only allow them access to claim records and features of the ICE they would need to perform their tasks. Therefore, a user who works in the LC (105) division will generally only see an unassigned queue (111) of cases that still need to be assigned to someone in the LC (105) and not cases that are awaiting a representative of the VR (107) division, for example.

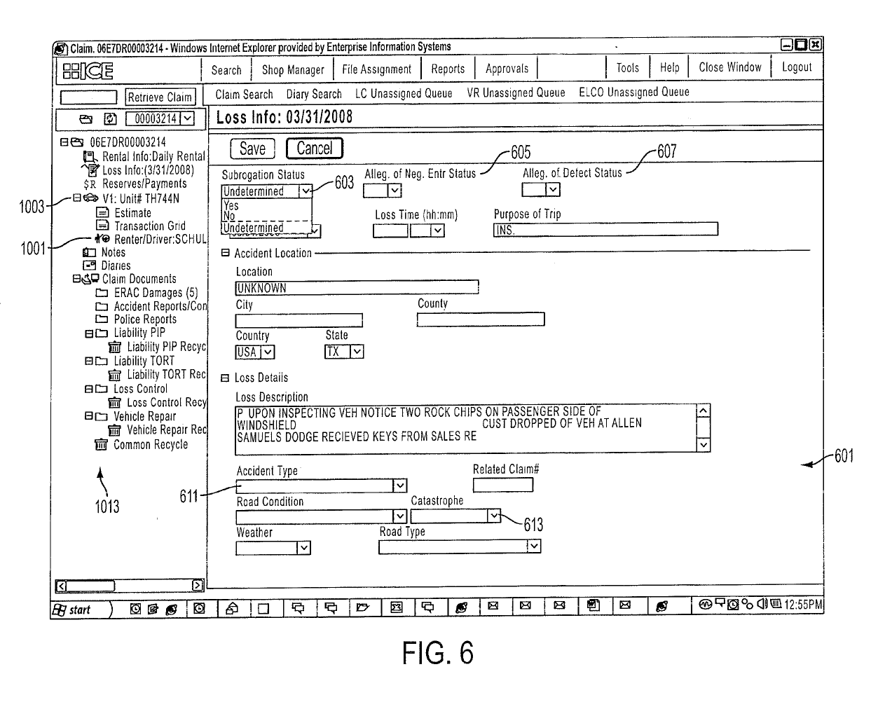

For further security or authority, certain actions within the ICE claim record (110) may also only be able to be taken by certain individuals. For example, the subrogation determination can generally only be made by someone in the LC (105) division, therefore, someone who is in the VR (107) may be able to access and view the determination, but may not be able to change it, as having logged in as working in the VR (107), they are not allowed to make that determination. Alternatively, only someone in the LCO (103) may be able to alter whether an allegation of negligence (605) or defect (607) as shown in FIG. 6.

As can be seen in FIG. 1, once the claim report is placed in the ICE (101) and appears in a queue (111) for unassigned ICE claim reports (110), it may then be taken up by either the Loss Control (LC) (105) or Vehicle Repair (VR) (107) divisions. The LC division (105) is interested in determining the loss to the owner from the damage inflicted to its own property and recouping that loss if possible. Specifically, the LC (105) division will be interested in determining the cost to the owner to get the vehicle back on the road (or replaced) as well as the indirect costs of the vehicle being out of service. For example, since the vehicle is not a capital expense which is simply used as part of the business but is intended to be earning rental fees, the loss of the vehicle as a viable rental vehicle can create additional costs from lost rental income, costs to provide a temporary replacement vehicle, or similar costs which may not be present if the vehicle was not intended to provided a stream of income.

Because the rental industry interacts with many different types of insurance and there may be a number of different insurance products involved, the determination of who is responsible for these costs can be complicated. In just a simple transaction, the renter may have their own vehicle insurance which may at least partially cover the incident. The renter may have obtained additional liability protection by the use of a specific credit card account to make the rental, and the renter's employer may have applicable insurance. Therefore, the LC (105) will generally need to have access to this information to determine liability. Further, the various entities may have different limits on their financial responsibility, and therefore the LC (105) needs to be able to assess responsibility to multiple different entities.

The other division accessing the initial unassigned queue is the Vehicle Repair (VR) (107) division. While the LC (105) is concerned with the accounting of the vehicle including direct and indirect costs associated with repair, the VR (107) is principally concerned with getting the vehicle repaired. While there is a cost component in the repair of making sure that the repairs are done for a reasonable amount, the VR (107) division is principally concerned with knowing the timing until repair completion, the steps that are being taken or need to be taken to get the vehicle functional again, and the amount that the repair actually costs. If the vehicle is too badly damaged, there is a need to determine that the vehicle will be unable to continue to serve its purpose, and needs to be removed from service, generally obtaining as much recompense for its value as possible.

As should be apparent from the above, information needs to be able to flow between the various divisions of the owner. Specifically, eyewitness accounts of the accident, police reports, and contract information related to the renter can be valuable to the divisions as background and to enable decisions to be made. Further, cost and time estimates provided by a repair facility are useful not, just to plan the repairs, but are also needed to prepare accounting to determine how the costs are to be allocated.

In addition to the exchange of underlying information, exchange of results and determinations of the parties is also very valuable. For example, if the LC (105) knows that there is a potential claim related to a mechanical failure of the brakes of a vehicle, it may be necessary to preserve the vehicle without repair to avoid loss of potentially valuable evidence. Therefore, when the LCO (103) becomes aware of this concern, this needs to be passed to the VR (107) and LC (105) to make sure that actions are not taken on the vehicle which could result in loss of evidence. Similarly, if the LC (105) has prepared accounting with an estimation that the vehicle will be out of service for 10 days and due to parts being backordered the VR (107) is made aware that it will actually be 20 days, it may be necessary for the LC (105) to modify its accounting.

Previously, this interchange of information was fragmentary with each individual division concerned only about its own interests. Communication between them often required direct correspondence between individuals which could be time consuming and difficult to keep track of Computer systems exist which provide for the centralization of estimate and repair information as well as contractual and similar information, but these did not interlink with loss control information. This meant that much information was not actually shared, or was shared only when requested. Sometimes, the exchange may occur too late for the information to be valuable in another place.

Let's look at how the claim record is handled in the depicted embodiment of the ICE (101) by the VR (107) division first. In this instance, the VR (107) may receive notification that there is a claim representing a damaged vehicle which needs to be repaired placed in the queue (111). Generally, the VR (107) will accept a case from the queue (111) which will allow them to have access to the claim report (100) and become responsible for keeping it updated, and closing it once repairs are completed. Once accepted, the ICE claim report (110) will generally be removed from the queue (111), with regards to being taken by VR (107), however, it may still appear as needing to be taken up by LC (105).

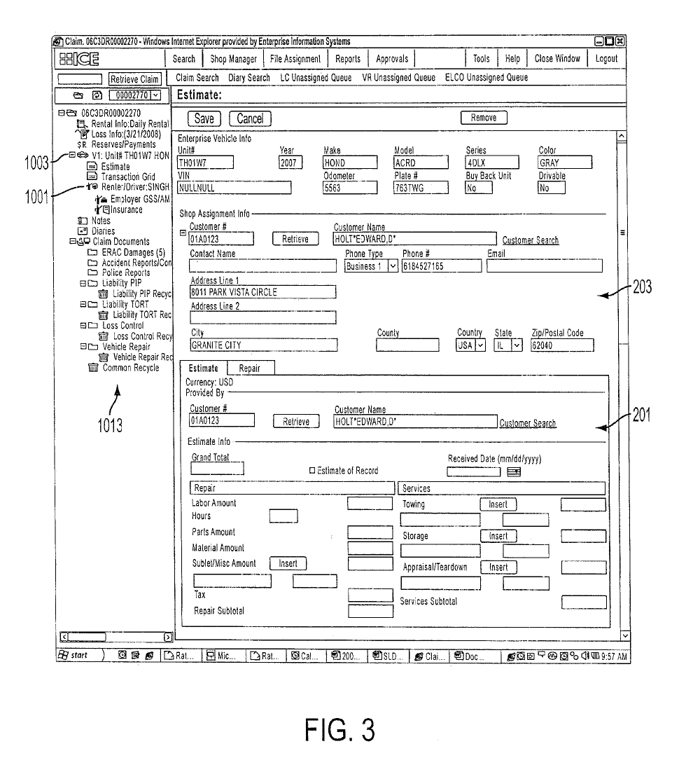

The first stage of the repair, once the VR (107) has accepted the ICE claim report (110) from the queue (111), is to open it, confirm responsibility (173) and begin work (175). In this work stage the VR (107) generally needs to obtain and enter a repair estimate. This is generally obtained in any fashion and it often will be provided by separate computer systems which allow for the provision of estimates. The estimate is received from a repair facility that has been provided with the vehicle. The estimate will generally include cost estimates as well as indications of the time for completion of the estimate and other necessary information to schedule and complete the repair. Once this information is received by the VR (107), the VR (107) can begin to schedule the repair and will enter the information into their entry screen. An embodiment of such an entry screen is shown in FIG. 3 where items such as various costs (201) can be entered. Further, the VR (107) will generally have access to the basic vehicle information that was entered by the depot (102) in section (203) or accessed from customer records.

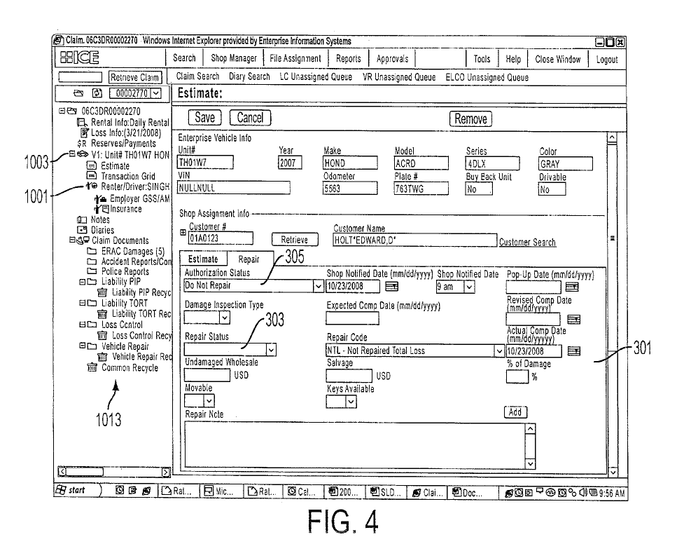

The VR (107) may also provide for repair details such as expected completion dates (301) and status of necessary repairs (303) and authorizations (305). A screen for entry of this type of information is shown in FIG. 4. Expected completion dates may also be calculated automatically by interfacing with other computer systems such as those described in U.S. patent application Ser. No. 11/747,645, the entire disclosure of which is herein incorporated by reference. Once the information is entered, the VR (107) will generally save the claim report (110) with the updated information as part of the ICE claim report (110). The VR (107) may then instruct the repair facility to begin repairs unless there is an indication elsewhere that repairs are not to be performed.

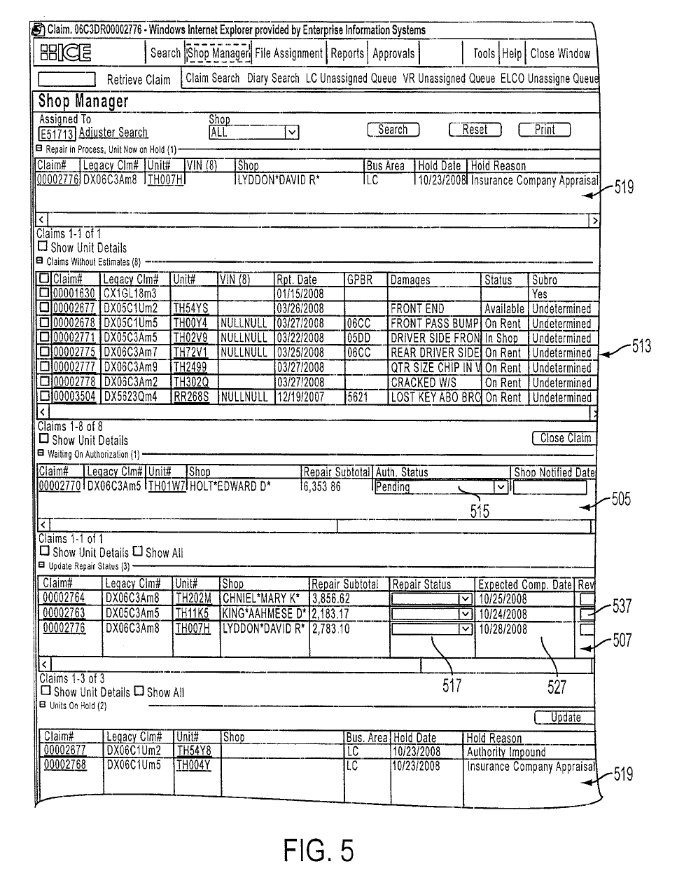

As the VR (107) is responsible for getting vehicles repaired, the VR (107) will generally need to be watching repairs in progress, altering estimates, and updating costs as they receive communication from the various repair facilities involved in these repairs they are responsible for. Further a VR (107) is often responsible for getting a large number of vehicles repaired and therefore will need to be able to update information quickly and efficiently so as to make sure that repaired vehicles are getting back to depots (102) where they need to be to meet rental demands, as well as making sure that repair facilities are not receiving too many vehicles and are thus falling behind in getting repairs completed. In order to assist with this, the VR (107) is provided with a specialized interface which is not geared to the collection of claim monies, but to facilitate the review and update of repairs. This element is called the shop manager (501) and is accessed via the shop manager tab. An embodiment of a screen display of a shop manager is shown in FIG. 5.

As indicated, the VR (107) is responsible for getting the vehicles repaired and making sure that vehicles spend as little downtime as possible. Because of this, the shop manager (501) will generally be more focused on where the vehicles stand on being repaired and providing an easy place to enter updated information. While the VR (107) can still use the standard ICE claim report (110) entry screens such as those shown on FIGS. 2 and 3, these are often more cumbersome and the shop manager (501) can provide for a more streamlined interface. Specifically, the shop manager (501) is focused on entering information relating to the vehicle's repair schedule and the costs of the repair, The shop manager (501) will also generally only be available to those in the VR (107) division (as indicated by their log in information) as other divisions would not need this type of streamlined interface.

In the embodiment of FIG. 5, there are basically five different sections which provide listings of vehicles. Each of these sections can be expanded or contracted to provide for more or less information on the screen at any time. In FIG. 5, the sections are all expanded. In FIG. 5 there are first listed vehicles where the VR is waiting on a repair estimate (503). These are effectively in the first stage of repair where the repair is not yet proceeding and the timing is the most uncertain. In these cases, nothing has been entered so the user is not provided with a quick entry as part of the shop manager (501) and only has the option of opening the claim record via a link (513). This may be necessary since the entry of the estimate generally requires input of a large amount of information Once the VR (107) has received the estimate, the claim report (110) will be updated. Changing of the status of the claim report (110) from awaiting an estimate to a status such as awaiting authorization or under repair will generally cause the claim record (100) not to be listed in this section (503) but to appear in another one.

Once estimate information has been entered, the claim report (110) reference in the shop manager (501) moves into one of the next two sections (505) and (507). In these sections, changes to the relevant categories that are most likely to be used can have information updated directly from the shop manager (501). There is no need to update the claim report (110) by opening it. The shop manager (501), therefore, becomes the entry screen for VR (107) personnel and provides for an easy to use interface to maintain records on the status of repairs. As can be seen in FIG. 5, instead of having to open the individual claim report (110) and go through it to get to the correct section to update the status of the repair, the user can instead alter the information which is directly effected by a change of status of the vehicle. Thus for a vehicle awaiting authorization to repair which are in section (505) of the screen, when the authorization is received, the user can directly enter that change into a drop down menu (515) from this screen and indicate when repairs have been authorized. This will move the claim report (110) from section (505) to section (507) where vehicles that are in repair are listed.

For vehicles being repaired in section (507), the user can update the in-process repair status. This allows for better tracking to estimate times to completion as well as indicating where a repair may be taking longer than expected. The user may update the expected completion date (527) if more information is obtained or a situation changes. They may also alter the current status as repairs are completed or as additional items are identified (517). The system also provides for a tickler system (537). Using this system the VR (107) personnel may provide for a date they would like to obtain a reminder from the system about a particular claim report (110). In this way, the VR (107) can receive reminders on the days that repairs are expected to be completed so they can follow up and make sure the repairs are still on schedule. Further, if there was an action with an expected date of completion, for example the arrival of a part that was on order, the VR (107) can also use the tickler date to notify them of this so that they can call the repair facility and determine if the part has arrived and the revised completion date based upon that information.

Finally, the shop manager (501) may have a section of vehicles on hold. This section can provide for one of those places where a VR (107) representative may have access to information but cannot necessarily change it. These are vehicles which for some reason cannot be repaired but this particular representative has had associated to their ID and are their responsibility. Most commonly, vehicles will be on hold because the vehicle needs to be maintained as evidence due to the actions which may have been taken by an LCO (103). As can be seen, there are no quick change sections for on-hold vehicles. This is essentially because on-hold vehicles are not under the control of the VR (107) as they are not supposed to be having them worked on. Therefore they would not need to be updating these entries on a regular basis. The VR (107) can, however, still access the full claim record via link (519) as there may be things which do need to be changed. For example, the vehicle may be towed from a repair facility to a storage facility and the VR (107) would need to indicate the change of location and new towing cost.

As part of the shop manager (501), the shop manager (501) may allow for personnel from the VR (107) to search or organize the vehicles they are responsible for based on various criteria. For example, they may want to know how many vehicles are currently in for repair at a particular repair facility so that they keep vehicles flowing to a variety of repair facilities and don't have a specific facility become bogged down and delayed because they are receiving too many vehicles to repair. Similarly, they may want to make sure that a vehicle repair provider is not being inadvertently bypassed in having vehicles sent to it. While such general overviews can be useful to the VR (107) and may be implemented as part of the shop manager (501), they may also be implemented as a global feature (109) useable by multiple divisions.

The shop manager (501) may also provide for simplification of the VR (107) to return a vehicle to service and close the VR's (107) portion of the claim report (110). As is shown in FIG. 1 and discussed later in this discussion, when the various entities have completed their actions on the claim report (110), they will close (113) their portion of the report (110) so as to indicate that their portion is completed, remove it from their responsibility, and allow the report (110) to close completely once everything has been handled on it. Because repairs will generally be completed in the normal course of action as opposed to because of a specific modification that needs to get entered into the claim report (110), instead of requiring the VR (107) to go into the specific claim report and then indicate that it is closed, the VR (107) can instead indicate that a vehicle is repaired in the repair status (517) on the shop manager (501). At that point in time, the ICE (101) can identify that this claim (110) is closed from the VR (107) and remove it from their pending cases, as well as remove it from the shop manager (501) display.

As should be apparent, as the repair status (517) can be modified from the shop manager (501), the shop manager (501) can therefore provide for a simplified interface for VR (107) personnel for carrying out most of their modifications and actions on the specific claim report (110). In effect, the only time the VR (107) personnel need to open the claim report (110) is when they first enter the estimate information. After that time, they can make all the expected changes using the shop manager (501). This provides significant benefits by allowing the VR (107) to not only have access to the claim report and provide for information modification in the claim report, but to do so utilizing a streamlined interface designed to make it easier to enter the type of information they routinely work with.

While the above has discussed the VR (107) actions on the claim report (110), the LC (105) may also associate the claim report (110) to themselves (153) and provide their analysis and determinations (155) as part of the report (110). Also, like the VR (107) the LC's (105) input is generally required before the claim report (110) can be considered closed. The LC (105) will generally be concerned with making sure that the costs of the repair are allocated and recovered where a third party is responsible or are correctly allocated to the owner where the owner is responsible. Similarly, the LC (105) may review the claim report (110) and determine if there is need to forward the case (157) to the LCO (103) as there may be potential liability for the owner beyond the costs of repairs.

Should the LC (107) determine that there is a liability concern, the LC may forward the claim report (157) to the LCO (103) or provide notice to the LCO (103) that further review of the case is necessary. Generally, if the LC (105) determines that the LCO (103) needs to be involved, they will indicate that there is a liability concern which will place the claim report (110) into the queue (131) for the LCO (103). As in the previously discussed queue (111), claim reports placed in an LCO queue (131) will generally be accepted by (133) a LCO (103) representative and will be processed (135). Once a case is sent to the LCO queue (131) it generally cannot be closed until the LCO (103) has signed off on it. Generally, the LCO (103) will either determine that there is no liability or that there is liability concern. In the later case, their ICE (101) may work in the same manner as traditional software designed to handle insurance claims with the LCO (103).

Specifically the LCO (103) will serve to help the owner determine if it has any liability and the extent of that liability. The LCO (103) may also serve to provide initial settlement offers on the liability issue. In effect, the LCO (103) is responsible for determining the amount of money that the owner will owe the third party involved in the accident. As the LCO (103) comes into play where the owner is financially responsible for damage to another, its involvement is not needed in all cases. For this reason, the LCO (103) is generally not notified of the claim report (110) or required to access and act on it to close the claim report (110). Instead, the LCO (103) generally only gets involved when the LC (105) indicates that there is reason for the LCO (103) to be involved.

For the most part, the actions taken by the LCO (103) once they access the claim report (110) are not part of this disclosure. Instead, the LCO (103) is simply treated as a division which needs to be brought in when the LC (105) determines that there is potential financial responsibility on the part of the owner, and the LCO (103) needs to have access to and sign off on the claim record after the determination to bring them in has been made.

Since the concern here is liability of the owner, in some cases it may be the situation that the inquiry does not need to proceed as the owner may not be liable. At the same time, even if they are not at fault, various state or federal laws may require them to have potential liability. Thus, it generally will be necessary for the LCO (103) to be able to get information from the claim report (110) in the hands of claims adjusters to determine the potential liability and to get the liability issue resolved for an amount certain at the earliest opportunity Actions of the LCO (103) beyond their becoming involved are not discussed in greater detail herein as they are beyond the scope of this discussion and software for performing claim adjustment functions is generally known and the ICE (101) may use such known software functionality.

FIG. 6 provides for the basic indication of actions by the LC (105). This screen shows the first actions that will generally follow from the LC (105) accepting of a claim report (110). The first requirement of the LC (105) is to review details (601) and see the nature of the accident and if the owner would expect to be able to collect the repair cost from a third party. Some of these details (601) will have been provided as part of the initial claim report (100) as entered by the depot (102). The LC (105) may also enter additional information such as providing indications of specific types of accidents (611) or indicating that the accident is part of a claim including multiple vehicles (613) such as if a tornado hit a specific depot (102). Generally, the most important determination made by an LC (105) is if the repair cost may be subrogated to another party. The question (603) of subrogation when a new claim is created will generally default to “undetermined” which is shown in the open menu (603). The LC (105) is generally not allowed to close an undetermined subrogation claim.

If this is a situation where the owner is responsible for the repair costs, for example if the accident occurred while the vehicle was been driven around the owner's lot by an employee or the renter purchased protection through the owner which waived the contractual clause that the renter was responsible for damage to the vehicle, then the subrogation indication (603) is usually set to no. This may complete the subrogation inquiry and then the claim report (110) can be closed by the LC (105) as there is no need for the LC (105) to further consider the claim report (110) as the owner is responsible for all charges. In this case, nothing else will generally happen as the LC (105) has determined that the owner is responsible for the loss and therefore it is simply recorded as such.

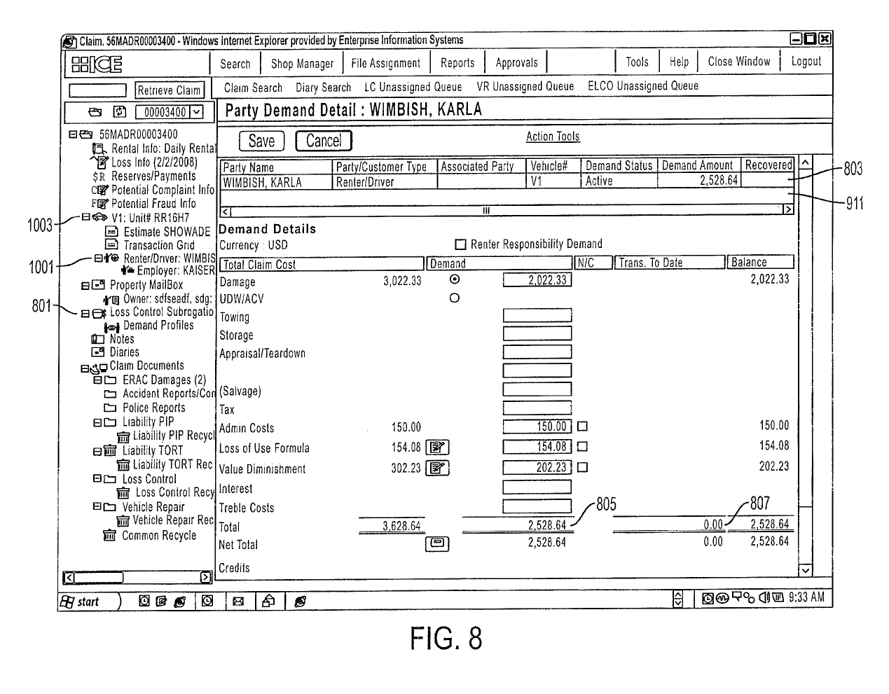

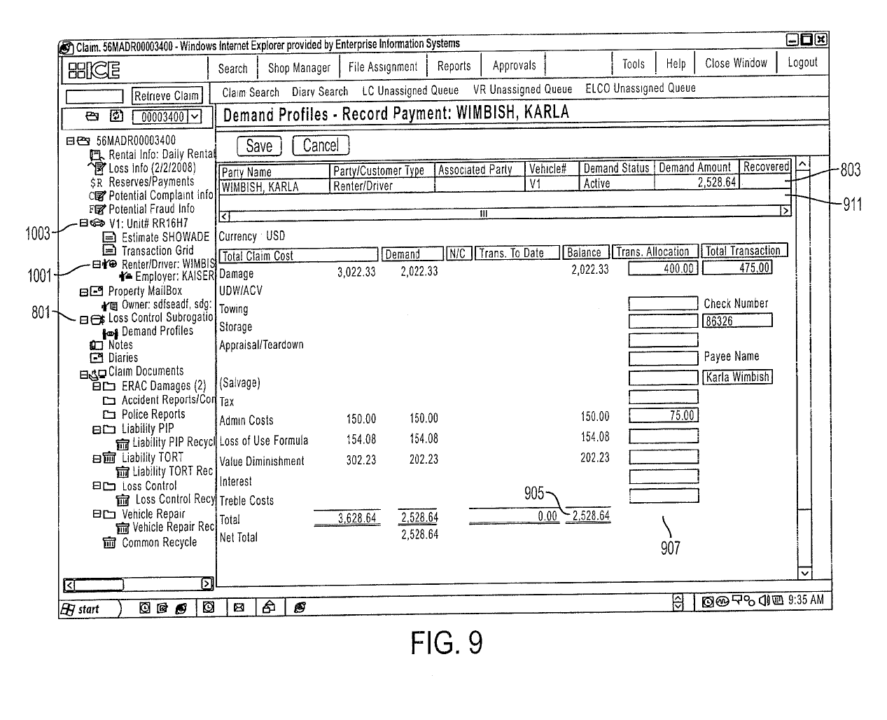

If there is a third party to potentially collect from, the subrogation question (603) will be answered yes. This will generally create a whole new portion of the organization tree (1013) of the ICE (101) as the claim report will now need additional components related to the collection actions. A branch (801) for this additional compliance is shown in FIGS. 8 and 9. These new portions of the claim report (110) will then be filled out by the LC (105) representative which allows them to now work through actions to send out bills and to arrange for the collection of monies to recoup the loss.

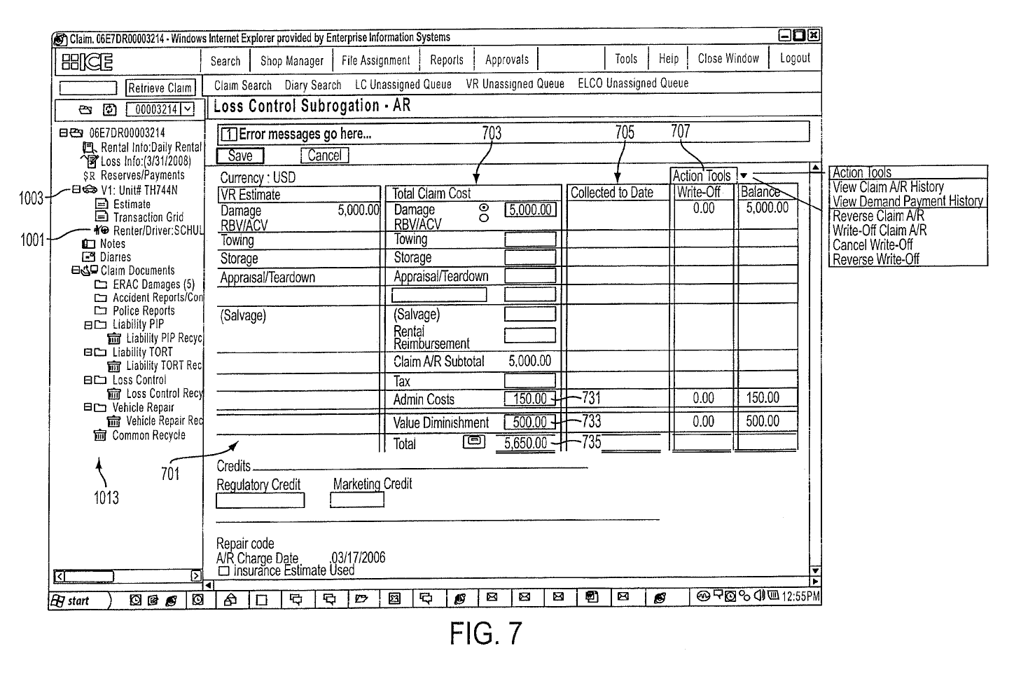

The principle cost calculation screen for an LC (105) is that shown in FIG. 7. This screen is used to enter total costs and to determine total cost of repair. No responsibility has yet been assigned in FIG. 7. Generally, the estimate and actual cost of repairs will pre-populate the first portion (701) of this screen as they are entered by the VR (107). These numbers may then be adjusted by the LC (105) to take into account additional charges (for example if there is a towing charge which was prior to VR (107) being involved with the repair, and to which they did not have access, it may be added) or to alter charges if circumstances warrant in the second column (703).

Similarly, the LC (105) may simply decide to not bill out a total amount from an estimate, may not be able to bill out a certain amount or charge due to an agreement, or may choose to disregard certain costs in this particular case. Such disregarded costs may be, in an embodiment, internal costs such as, but not limited to, administrative costs (731) which may be based on a formula to recoup costs of having to pay for the resources used in determining and collecting the cost, the value diminishment of having a damaged and repaired vehicle (733), and loss of use costs related to the amount of time the vehicle spent not being able to be rented. These types of administrative costs may be estimated or computed based on the costs of repair, value of the vehicle, agreed rates, etc.

Once the LC (105) has determined the total account amount that is owed them on the vehicle (735), the LC (105) may then go to the screen of FIG. 8 which provides for them to assign these costs to the various parties which are part of the claim record (110). For example, if the renter has insurance with a $1000 deductible, and this information is known to the owner, the owner may setup a receivable in the amount of $1000 for the renter and the remainder for their insurance carrier. The ICE (101) may then be used to generate letters or other documents to use to try and collect on the account or information from the claim report (110) may be made available to other programs for this purpose.

In FIG. 8, a demand has been determined to be made of the renter (803) in a slightly reduced amount of $2,528.64 compared to the total cost of repair entered in FIG. 7 of $3,628.64. The adjustment was made in column (805) which allows for this type of change to be entered. Once the amounts are finalized, they may be entered and a demand or bill may be sent. As can be seen in FIG. 8 the total outstanding balances (807) for this party (803) reflects only what is specific to them, not the total balance for the whole repair.

As collection actions proceed, the LC (105) may adjust the various accounts which have outstanding amounts to reflect payments. An example of this is shown in FIG. 9. As parties pay some or all of their current obligations, payments can be placed in the spreadsheet of the receivables so as to keep a constant running tab of what is collected vs. what is still outstanding. In FIG. 9 the existing owed balance is for the same responsible party (803) and is shown in column (905). On this screen, however, the LC (105) may allocate payments against the various balances in column (907). This allocation may be by simple internal assignment, or may be based on statements of the responsible party (803). For example, a partial payment may not be allocated to a loss of use charge should the responsible party (803) deny owing that charge but pay on other charges.

As can be seen in FIG. 9, the responsible party (803) can be joined by other parties in the demand listing (911) should there be more than one responsible party. Further, updating any individual responsible party may also provide updated information (705) in the main LC screen of FIG. 7 which reflects the total of all collection efforts with all responsible parties.

So long as there is an unreconciled balance in the claim report (110), generally the LC will have this claim as an open claim report (110). Further, if changes in responsibility are provided, for example if the renter provides proof of insurance after an initial demand is made of him or her, the responsibilities may also be altered to reflect the new situation such as by deleting or replacing a responsible party.

The LC (105) can generally only close the claim when either the receivable has been balanced and no money is owed by any party or when a determination has been made that a portion of the amount is being written off and the claim record needs to be closed. In the first event, once the amount has reached zero and the claim amounts are reconciled, the LC (105) will be able to indicate that the claim report (110) is completed and close the portion of the claim report (110) with regards to the LC (105).

If a determination is made by LC (105) that a receivable cannot be closed in normal fashion, then it is necessary to still reconcile the receivable and make sure there is a zero balance. In an embodiment, the system will only allow for a record to be closed by the LC (105) when it has a zero balance which means that the loss has been allocated and either recouped or written-off. In order to effect a write-off, the LC (105) will generally indicate a reason for the discrepancy and indicate the amount which is being written-off. The reasons can be anything from a marketing decision, to a decision that collection efforts are simply not cost effective and this is a bad debt, to the outcome of an arbitration, negotiated settlement, or trial. Regardless of the reason, this write-off amount will be indicated in column (707), and then the LC (105) will be allowed to close the claim report.

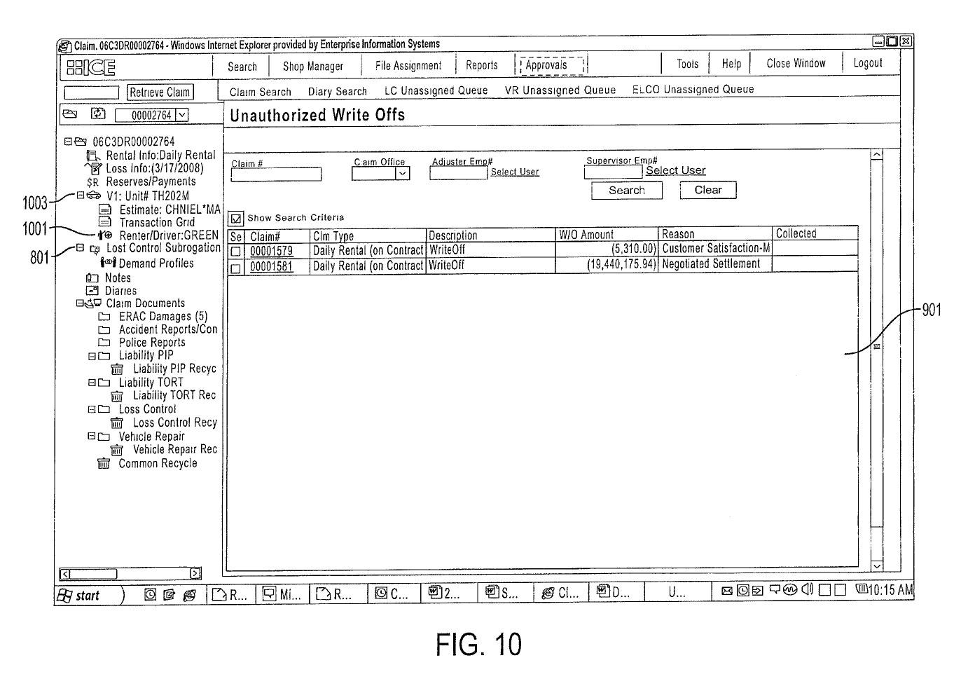

Depending on the nature of the write-off, the write-off may require approval. FIG. 10 provides a screenshot showing write-off requests awaiting approval. As discussed in prior situations, the claim reports (110) have again been queued awaiting review. In this case they are queued to await a specific party's approval to be closed since they include a write-off. For instance, the person acting as the LC (105) may not have the authority to determine that a debt should be uncollectible. In this case, the LC (105) may need to obtain authorization to do so, and the ICE (101) may provide notification to a manager or other individual responsible for making such determinations to make sure that it is authorized to write this cost off. This request for approval may occur before the claim report (110) is closed, or may occur after the claim report (100) is closed acting as a double check.

Regardless of the exact timing between them, once the LC (105) and VR (107) have both completed their portions of the analysis, the claim report (110) will generally be indicated as having been “closed” (113) with regards to each of them respectively. So for example, if the estimate was prepared, and approved, the VR (107) may take the case internally to schedule the work, have the work performed, and return the vehicle to the owner once the work is completed and close the claim report (110). Similarly, the LC (105) may indicate the ability to subrogate, take in the costs of repair, allocate those to responsible parties, collect the necessary costs, and then close the balanced claim report (100).

Once closed by all the responsible parties, the claim report (110) is removed from all queues and is simply placed into storage for records purposes. The claim report (110) may be able to be reopened at a later date should something change or if additional information needs to be added, but generally a completely closed claim report (110) will no longer be of interest except as a historical record.

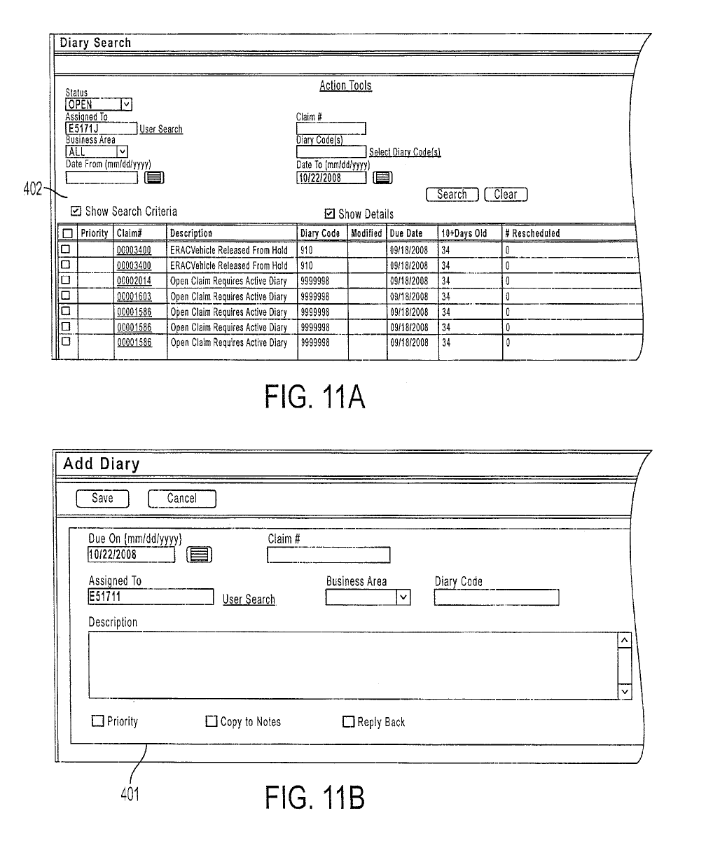

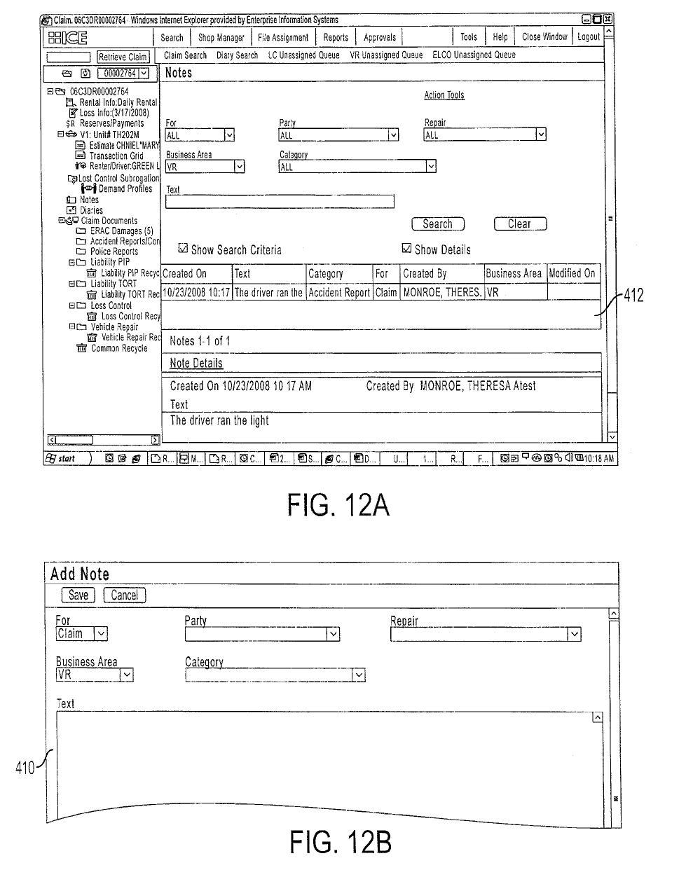

As discussed above, in addition to having specific data entry screens for the LC (105) and VR (107) the ICE (101) may also include general functionality (109) such as for record keeping. These items can provide for both automatic recording (such as when changes are made to a claim report (110)) or may provide places for users to enter notes. These notes may be designed for use by all the divisions, or may be specific to a division and inaccessible by others. FIG. 11 provides for an embodiment of a screen showing an automatic diary (401) of updates of estimates as an example of such record keeping along with a listing of all diary entries (402). FIG. 12 shows an embodiment of a screen showing a notes page (410) also related to updates of estimates and the listing of all notes (412) associated with a particular ICE claim report (110). FIG. 11 and FIG. 12 are clearly similar in that they allow for automatic or manual recording of additional information to be stored with the appropriate ICE claim report (110).

Integration of the information in the system should be clear from the above discussed embodiments. Specifically, the ICE system (101) allows for the updating of information related to the estimate and associated costs by the VR (107) into the claim report (101), and the use of this information directly by the LC (105) to determine how those costs should be allocated. In this way, there is no miscommunication. If the VR (107) determines that additional time is necessary for the repair and so indicates, the cost from a loss of use from that additional time may be automatically indicated, insuring that the cost is correctly allocated by the LC (105) since the information is provided to them automatically. The ICE (101), therefore, can provide for a communicating environment whereby information from at least two disparate divisions can be integrated in a single claim report with both working simultaneously to complete separate, but interrelated, tasks.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A method of managing claims for a fleet of vehicles, the method comprising:
having a fleet owner responsible for a fleet of vehicles;
providing a computer;
due to damage to one of said vehicles, having a depot of said owner create a claim report in said computer;
allowing a Vehicle Repair (VR) division of said owner to access said claim report and to update said claim report with repair costs and dates of expected repair completion;
allowing a Loss Control (LC) division of said owner to access said claim report to indicate if the loss can be subrogated; and
if the loss can be subrogated, allowing the LC to maintain an accounting as part of said claim report said accounting utilizing information entered by at least one of said VR and said depot.

2. The method of claim 1 wherein said VR can access said claim via a simplified interface which allows for updating of status of a repair without opening said claim record.

3. The method of claim 1 wherein said computer is part of a computer network.

4. The method of claim 3 wherein said computer comprises a server computer.

5. The method of claim 4 wherein said VR and said LC access said claim report on said server computer via separate client computers.

6. The method of claim 1 wherein said VR and said LC may simultaneously access said claim report.

7. The method of claim 1 wherein once said claim has been rectified, said claim report is closed.

8. The method of claim 7 wherein said claim report cannot be closed until both said LC and said VR individually close said claim report.

9. The method of claim 8 wherein said LC cannot individually close said claim report until they have indicated if there can be subrogation.

10. The method of claim 9 wherein said VR cannot individually close said claim report until they have indicated that said damaged vehicle has been repaired.

11. A computer-readable memory storing computer-executable instructions for claim management, the memory comprising:
computer-executable instructions for creating a claim report in said computer;
computer-executable instructions for allowing a Vehicle Repair (VR) division of an owner to access said claim report and to update said claim report with repair costs and dates of expected repair completion;
computer-executable instructions for allowing a Loss Control (LC) division of said owner to access said claim report to indicate if the loss can be subrogated; and
computer-executable instructions for allowing the LC to maintain an accounting as part of said claim report said accounting utilizing information entered by at least one of said VR and said depot if the loss can be subrogated.

12. A system of managing claims for a fleet of vehicles, the system comprising:
a fleet owner responsible for a fleet of vehicles, the fleet owner including a plurality of depots; and
a computer network to which said fleet owner and said depots have access, said computer network allowing:
said depot to create a claim report in said computer network due to damage of one of said vehicles in said plurality;
a Vehicle Repair (VR) division of said owner to access said claim report and to update said claim report with repair costs and dates of expected repair completion;
a Loss Control (LC) division of said owner to access said claim report to indicate if the loss can be subrogated; and
if the loss can be subrogated, allowing the LC to maintain an accounting as part of said claim report said accounting utilizing information entered by at least one of said VR and said depot.

13. The method of claim 9 wherein said VR cannot individually close said claim report until they have indicated that said damaged vehicle will not be repaired.
